(19) United States
(12) Patent Application Publication
(10) Pub. No.: US 2017/0001800 A1
(43) Pub. Date: Jan. 5, 2017

(54) STACKER CRANE

(71) Applicant: MURATA MACHINERY, LTD., Kyoto-shi (JP)

(72) Inventor: Mitsuaki FUKAYAMA, Inuyama-shi (JP)

(21) Appl. No.: 15/143,709

(22) Filed: May 2, 2016

(30) Foreign Application Priority Data
Jun. 30, 2015 (JP) 2015-131720

(51) Int. Cl. B65G 1/04; B66F 9/07

(52) U.S. Cl. CPC B65G 1/0407; B66F 9/07

(57) ABSTRACT

A stacker crane capable of improving space efficiency of a rack, and reducing cost for equipment using the stacker crane, without complicating structures of masts and a platform, includes a truck frame that travels on a track along a rack, a mast provided on the truck frame, and a platform that is raised and lowered along the mast. The mast includes a first mast that guides the platform, and a second mast located such that the platform is sandwiched between the first mast and the second mast in a travelling direction of the truck frame. As compared with the first mast, the second mast has a small width in the travelling direction of the truck frame, and has the same width as seen from the travelling direction.

### BACKGROUND OF THE INVENTION

1. Field of the Invention

The present invention relates to a stacker crane including a platform that is raised and lowered along a mast on a truck frame.

2. Description of the Related Art

A conventional stacker crane includes a rack capable of mounting a plurality of articles thereon, wherein the articles are mounted on the rack and are taken out therefrom. The stacker crane includes, for example, a truck frame that travels on a rail provided on a floor surface along a rack, and a mast on the truck frame. An article is passed between the stacker crane and the rack by using a transferring device provided on a platform that is raised and lowered along the mast (cf. Japanese Unexamined Patent Publication No. 2014-24658).

In the technique of Japanese Unexamined Patent Publication No. 2014-24658, two masts are provided on the truck frame to guide vertical movement of the platform while supporting a load from the platform. Since the two masts are provided on the truck frame, a space for the two masts is required. Further, for supporting the two masts, the truck frame is required to be provided in an area outside the two masts. Accordingly, the width in a travelling direction of the stacker crane becomes significantly larger than the width of the platform, and when the platform of the stacker crane is to be moved to a position at the rear-side end of the rack, the stacker crane is required to be located so as to protrude outward from the rack. Hence, a space for entry of the stacker crane is required by reducing an effective space for the rack for mounting articles, thus causing a problem of deterioration in space efficiency of the rack.

Similarly, a space is also required on the front side of the rack. For example, a belt conveyor may be used for movement of an article so as to pass the article to the stacker crane. In this case, in a state where the stacker crane is arranged on the frontmost side, the belt conveyor is required to be extended to the position of the platform in the stacker crane. This causes a problem of increasing cost for the belt conveyor.

In order to save the space required for the two masts in the stacker crane, one mast may support a load of the platform and guide the vertical movement of the platform. However, in this case, the mast and the platform are required to have greater strength than that of the two masts. This causes complicated structures of the masts and the platform, thus leading to a cost increase.

### SUMMARY OF THE INVENTION

Preferred embodiments of the present invention provide a stacker crane capable of improving space efficiency of a rack, and reducing cost for equipment using the stacker crane, without complicating structures of masts and a platform.

A stacker crane according to a preferred embodiment of the present invention includes a truck frame that travels on a track extending along a rack; a mast provided on the truck frame; and a platform that is raised and lowered along the mast. The mast includes a first mast that guides the platform, and a second mast that is located such that the platform is sandwiched between the first mast and the second mast in a travelling direction of the truck frame. As compared with the first mast, the second mast has a small width in the travelling direction of the truck frame, and has the same width as seen from the travelling direction.

With this configuration, as compared with the first mast, the second mast has a small width in the travelling direction, and has the same width as seen from the travelling direction. For this reason, the width in the travelling direction of the truck frame is able to be made small without reducing, as much as possible, the strengths of the first mast and the second mast in the width direction seen from the travelling direction of the truck frame. Further, since the two masts are used, a space occupied by the stacker crane in the travelling direction is able to be made small without complicating the structures of the masts and the platform. Accordingly, the space efficiency of the rack is improved, and cost for equipment using the stacker crane is significantly reduced.

The first mast and the second mast may have the same structure that extends across a width direction seen from the travelling direction.

With this configuration, since the first mast and the second mast have the same structure that extends across the width direction seen from the travelling direction, the configurations of guide rollers where the platform abuts on each of the two masts is able to be made uniform. That is, since the shapes of portions of the two masts that guide the platform are able to be made the same, application of a load between the platform and the first mast is able to be easily made equal to application of a load between the platform and the second mast. Accordingly, the balance of weight of the platform in the travelling direction is able to be easily maintained without complicating the configuration of the platform. Further, the manufacturing of the platform is able to be reduced.

Each of the first mast and the second mast may be a sheet metal mast including a roller abutting member which is a plate-shaped member on a platform side and on which a roller included in the platform abuts, a back-side member that is a plate-shaped member opposite to the platform and facing the roller abutting member, and a coupling member that is a plate-shaped member that couples the roller abutting member and the back-side member. The coupling member of the first mast may have a larger width than a width of the coupling member of the second mast.

With this configuration, each of the first mast and the second mast is a sheet metal mast, and the widths of the first mast and the second mast in the travelling direction are made different only by making the widths of the coupling members different. For this reason, the roller abutting member and the back-side member other than the coupling members are able to be made common between the first mast and the second mast. Accordingly, the cost for manufacturing the first mast and the second mast is significantly reduced.

The plate-shaped member of the first mast may have a larger thickness than a thickness of the plate-shaped member of the second mast.

For this reason, by making the thickness of the sheet metal mast of the first mast larger than the thickness of the sheet metal mast of the second mast, it is possible to improve the strength of the first mast to which a load due to its self-weight is likely to be applied.

According to various preferred embodiments of the present invention, it is possible to improve the space efficiency of the rack and reduce the cost for equipment using the stacker crane, without complicating the structures of the masts and the platform.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating an outline of a configuration of an automated storage according to a preferred embodiment of the present invention.

FIG. 2 is a front view illustrating an outline of a configuration of a stacker crane according to a preferred embodiment of the present invention.

FIG. 3 is a perspective view illustrating appearances of a first mast and a second mast according to a preferred embodiment of the present invention.

FIG. 4 is an exploded perspective view of the first mast according to a preferred embodiment of the present invention.

FIG. 5 is an exploded perspective view of the second mast according to a preferred embodiment of the present invention.

FIG. 6 is a view illustrating cross-sectional structures of the first mast and the second mast and the positional relation between guide rollers of a platform and each of the first mast and the second mast according to a preferred embodiment of the present invention.

### DETAILED DESCRIPTION OF THE PREFERRED EMBODIMENTS

Hereinafter, stacker cranes according to preferred embodiments of the present invention will be described with reference to the drawings. The drawings are schematic, and do not always illustrate the stacker cranes exactly.

In addition, preferred embodiments which will be described below illustrates specific examples of the present invention. Values, shapes, materials, components, arranged positions and connected states of the components, assembling method, and assembling order which will be illustrated in the following preferred embodiments are examples, and are not intended to limit the present invention. Further, the components in the preferred embodiments which are not recited in the independent claim representing a generic concept will be described as optional components.

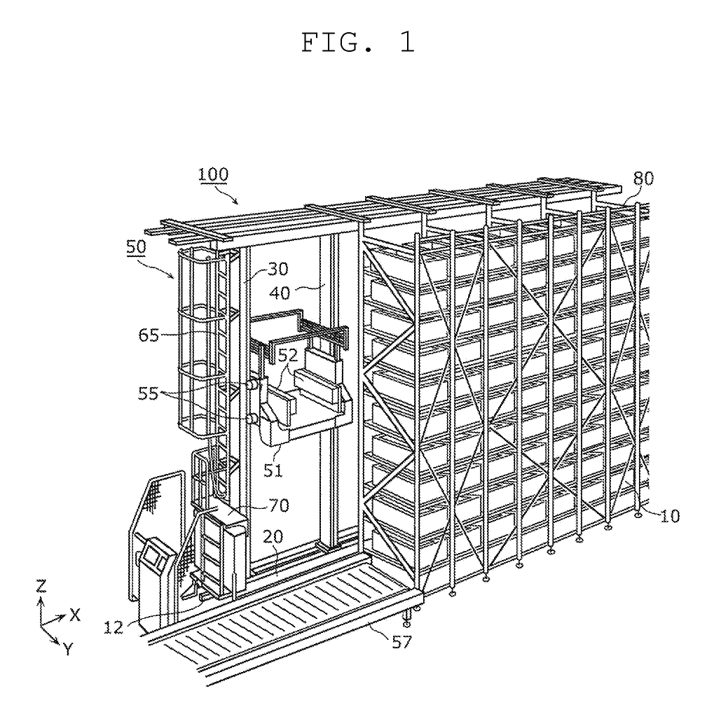

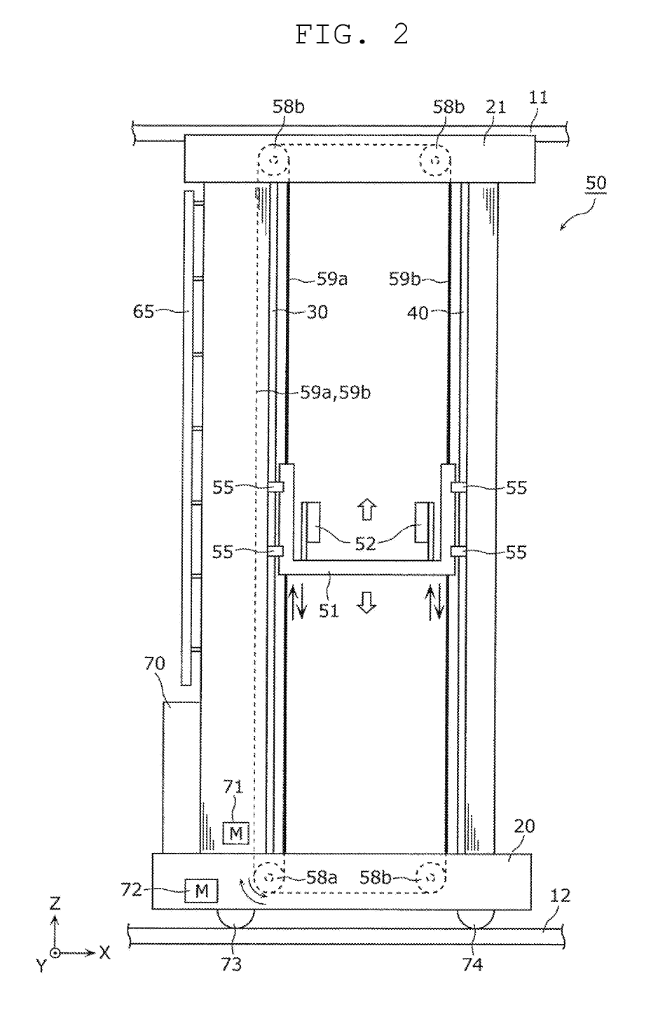

First, with reference to FIGS. 1 and 2, the outline of configurations of an automated storage 100 and a stacker crane 50 according to a preferred embodiment of the present invention will be described.

FIG. 1 is a perspective view illustrating the outline of the configuration of the automated storage 100 according to the present preferred embodiment. FIG. 2 is a front view illustrating the outline of the configuration of the stacker crane 50 according to the present preferred embodiment.

As illustrated in FIGS. 1 and 2, the automated storage 100 according to the present preferred embodiment includes a rack 80 on which a plurality of articles 10 can be mounted, and the stacker crane 50.

The stacker crane 50 includes a truck frame 20 that travels along a lower rail 12, two masts 30, 40 provided on the truck frame 20, and a platform 51 that is raised and lowered along the two masts 30, 40. The automated storage 100 further includes an upper truck frame 21 that travels along an upper rail 11. Further, the automated storage 100 includes a control board (controller) 70 that controls operation of the stacker crane 50.

The truck frame 20 includes in its lower portion a drive wheel 73 and a non-drive wheel 74. The truck frame 20 travels along the lower rail 12 in accordance with rotation of the drive wheel 73 by a travelling motor 72 that is driven by the control board 70. The non-drive wheel 74 is rotated on the lower rail 12 when the truck frame 20 travels by the drive wheel 73.

The two masts 30, 40 have a first mast 30 arranged on an X-axis direction negative side, and a second mast 40. The first mast 30 and the second mast 40 are aligned in a travelling direction of the truck frame 20 (X-axis direction) with the platform 51 sandwiched therebetween.

As illustrated in FIG. 2, the platform 51 is suspended by wire ropes 59a, 59b, which are guided by a driving sheave 58a and a plurality of fixed sheaves 58b. The platform 51 is raised and lowered, while being guided by the two masts 30, 40, in accordance with rotation of the driving sheave 58a by a lifting motor 71 that is driven by the control board 70. Further, the platform 51 includes a plurality of guide rollers including first rollers 55 to be guided by the two masts 30, 40 as described above. The platform 51 arranged between the two masts 30, 40 is raised and lowered while being guided by the two masts 30, 40 in a state where the plurality of guide rollers abut on the two masts 30, 40.

Note that the number of wire ropes suspending the platform 51 is not particularly limited, and for example, as illustrated in FIG. 2, the platform 51 is suspended by the wire ropes 59a, 59b each connected to the right and left sides of the platform 51. The wire ropes 59a, 59b are arranged so as to pass through the inside of the first mast 30, of the two masts 30, 40. Specifically, both ends of the wire rope 59a are fixed to the upper end and the lower end on the X-axis direction negative side of the platform 51. The wire rope 59a passes through the side of the first mast 30 and the inside of the first mast 30 via the two sheaves 58a, 58b on the X-axis direction negative side. Both ends of the wire rope 59b are fixed to the upper end and the lower end on an X-axis direction positive side of the platform 51. The wire rope 59b passes through the side of the second mast 40 and the inside of the first mast 30, of the two masts 30, 40, via the four sheaves 58a, 58b.

As compared with the first mast 30, the second mast 40 has a small width in the travelling direction (X-axis direction) of the truck frame 20, and has the same width as seen from the travelling direction. For this reason, the strengths of the first mast 30 and the second mast 40 in the width direction (Y-axis direction) seen from the travelling direction (X-direction) are not reduced as much as possible. Then, the width in the travelling direction of the truck frame 20 is able to be made small. Moreover, since the two masts 30, 40 are used, a space occupied by the two masts 30, 40 in the travelling direction is able to be made small without complicating the structures of the masts and the platform. Accordingly, the space efficiency of the rack 80 is improved, and cost for equipment using the stacker crane 50 is significantly reduced.

The control board 70, the lifting motor 71, and the travelling motor 72 are located on the first mast 30 side extending on the X-axis direction negative side, of the two masts 30, 40 of the stacker crane 50, and supported by the first mast 30. Further, a ladder 65 for a worker to climb up and down along the first mast 30 for maintenance work is fixed to the first mast 30.

As thus described, the control board 70, the lifting motor 71, the travelling motor 72, the ladder 65, and the like, which are devices and members having relatively large weight, are arranged on the side on which the first mast 30, of the two masts 30, 40, having a larger width in the travelling direction is provided. This is because the first mast 30 has a larger width in the travelling direction than that of the second mast 40, and has a greater strength than that of the second mast 40.

The stacker crane 50 having such a configuration moves as a whole in a direction in which each of the rails 11, 12 extends (X-axis direction in FIG. 1), with the truck frame 20 travelling along the lower rail 12 and the upper truck frame 21 travelling along the upper rail 11.

Further, a transferring device 52 is arranged on the platform 51 included in the stacker crane 50. The transferring device 52 according to this preferred embodiment uses a transferring method of transferring the article 10 by clamping or gripping the article 10 from the right and left by a side arm, for example. However, the present invention is not particularly limited to the transferring method used by the transferring device 52.

In accordance with an instruction from the control board 70, the stacker crane 50 travels along the lower rail 12, raises and lowers the platform 51, and extends and retracts the slide fork of the transferring device 52. The stacker crane 50 includes such a configuration to pass each article 10 between the rack 80 and a belt conveyor 57.

Note that the belt conveyor 57 is a conveyor that moves the article 10 to a carry-in port of the stacker crane 50 corresponding to the rack 80 so as to mount the article 10 onto the rack 80. In this preferred embodiment, the belt conveyor 57 extends in the X-axis direction so as to move the article 10 along the X-axis direction. The belt conveyor 57 may be another type of conveyor, such as a roller conveyor or a chain conveyor.

As described above, even when the belt conveyor 57 extending in the X-axis direction is adopted, the width in the travelling direction of the stacker crane 50 is able to be made small, thus enabling the stacker crane 50 to be located as close as possible to the X-axis direction negative side. Hence the length of the belt conveyor 57 is also able to be made small, and cost for the belt conveyor 57 is able to be significantly reduced.

The stacker crane 50 according to this preferred embodiment includes the two masts 30, 40 with unique structures. Hereinafter, the structural configurations of the two masts 30, 40 are described with reference to the drawings.

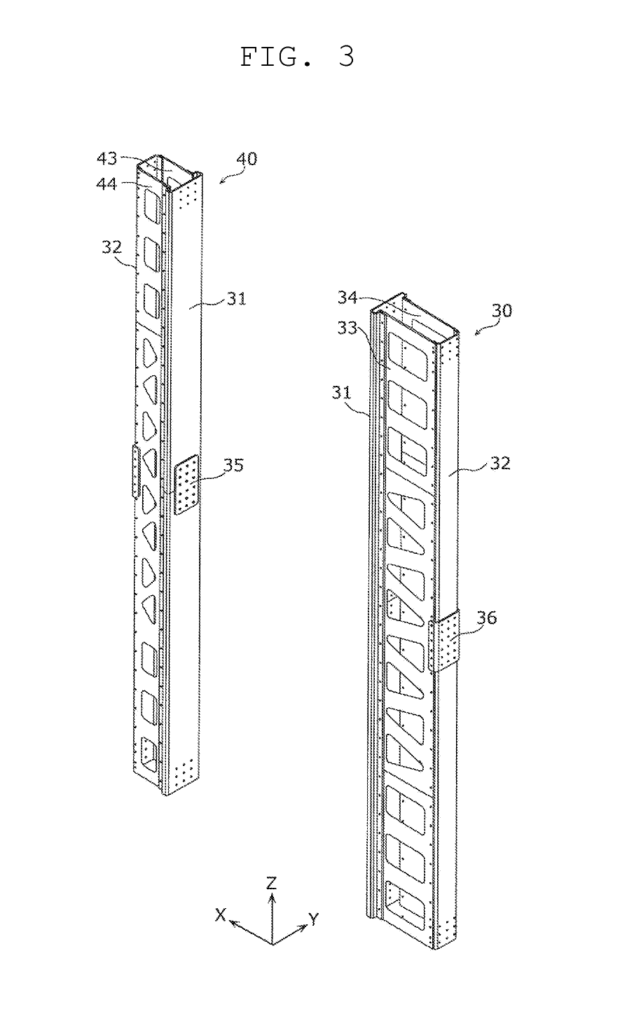

FIG. 3 is a perspective view illustrating appearances of the first mast 30 and the second mast 40 according to a preferred embodiment of the present invention.

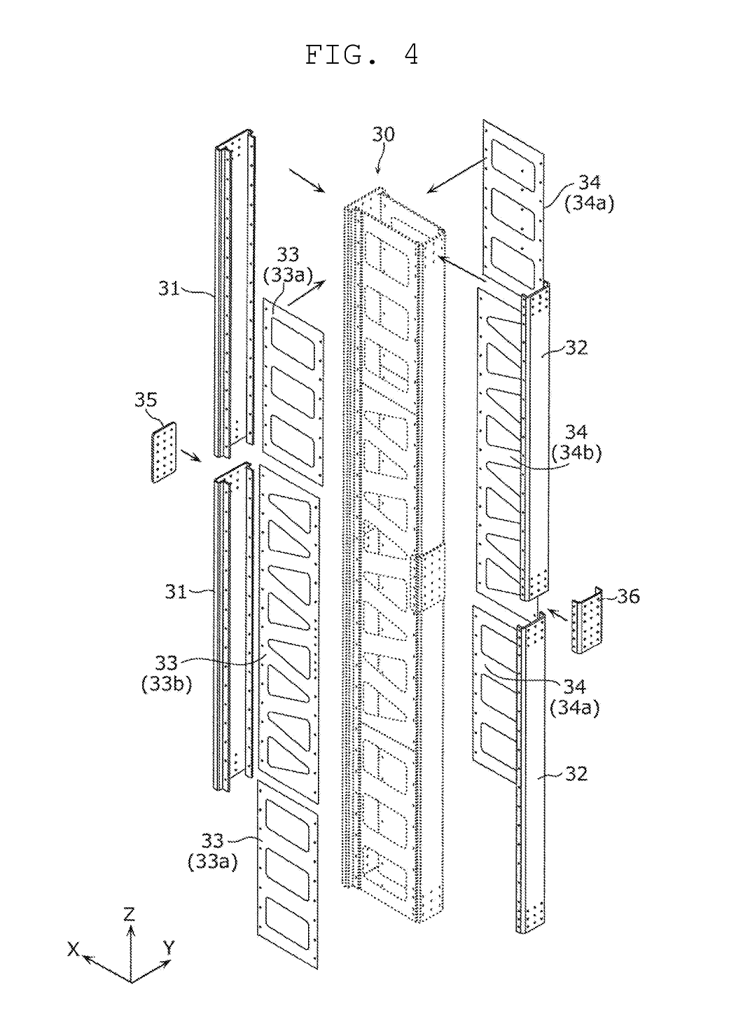

FIG. 4 is an exploded perspective view of the first mast 30 according to a preferred embodiment of the present invention.

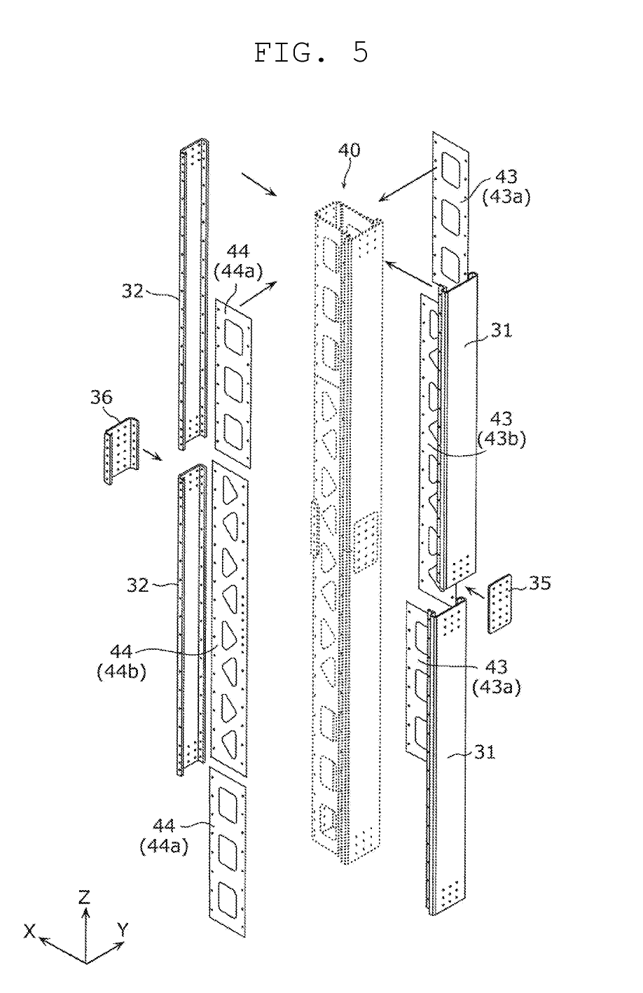

FIG. 5 is an exploded perspective view of the second mast 40 according to a preferred embodiment of the present invention.

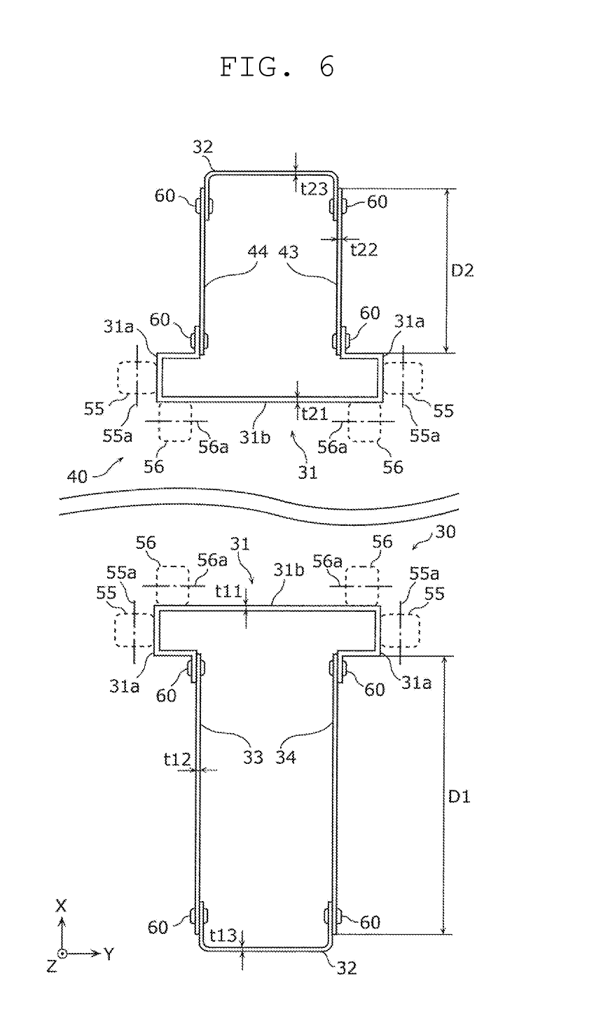

FIG. 6 is a view illustrating cross-sectional structures of the first mast 30 and the second mast 40 and the positional relation between the guide rollers of the platform 51 and each of the first mast 30 and the second mast 40 according to a preferred embodiment of the present invention.

FIG. 3 illustrates each of the first mast 30 and the second mast 40 having a length as a predetermined unit. For example, the first masts 30 illustrated in FIG. 3 are coupled in a height direction (Z-axis direction) to obtain the first mast 30 having a height required for the stacker crane 50. For example, a plurality of first masts 30 are coupled at a location where the stacker crane 50 is installed so as to have a height required for the stacker crane 50. The same applies to the second mast 40.

As illustrated in FIGS. 3, 4, and 6, the first mast 30 according to the present preferred embodiment includes a roller abutting member 31, a back-side member 32, and coupling members 33, 34. As illustrated in FIGS. 3, 5, and 6, the second mast 40 includes a roller abutting member 31, a back-side member 32, and coupling members 43, 44. The first mast 30 and the second mast 40 have the common roller abutting member 31 and back-side member 32, and have the coupling members with different configurations.

The roller abutting member 31 is a plate-shaped member on the platform 51 side, on which a guide roller included in the platform 51 abuts, in the first mast 30 or the second mast 40. Specifically, the roller abutting member 31 is a member in which a first plate material is folded to define a first abutting surface 31a on which each of the first rollers 55 abuts and a second abutting surface 31b on which a second roller 56 abuts.

Note that the first roller 55 and the second roller 56 are the guide rollers included in the platform 51. As illustrated in FIG. 6, a rotational axis 55a of the first roller 55 and a rotational axis 56a of the second roller 56 cross each other. The first roller 55 and the second roller 56 are preferably arranged such that their rotational axes cross each other. The positions in the height direction of the rotational axes of the first roller 55 and the second roller 56 may be different. In this preferred embodiment, the rotational axis 55a of the first roller 55 and the rotational axis 56a of the second roller 56 are perpendicular or substantially perpendicular to each other. That is, the first plate material is folded at a right angle (or a substantially right angle) to define the first abutting surface 31a and the second abutting surface 31b.

Further, in this preferred embodiment, the two first rollers 55 and the two second rollers 56 are located on the right and left sides in FIG. 6 of the platform 51 to sandwich the first mast 30 therebetween. For example, a set of four guide rollers is arranged vertically in each of two places of the platform 51. In this case, the platform 51 includes a total of eight guide rollers which abut on the one mast.

The back-side member 32 is a plate-shaped member located on the opposite side to the platform 51 and facing the roller abutting member 31. Specifically, the back-side member 32 is a member defined by a second plate material.

The coupling members 33, 34 are members that couple the roller abutting member 31 and the back-side member 32 in the first mast 30. The coupling members 33, 34 are plate-shaped members provided in positions facing each other. The coupling members 43, 44 are members that couple the roller abutting member 31 and the back-side member 32 in the second mast 40. The coupling members 43, 44 are plate-shaped members provided in positions facing each other.

A width D1 of each of the coupling members 33, 34 of the first mast 30 is larger than a width D2 of each of the coupling members 43, 44 of the second mast 40. A length in the Z-axis direction of each of the coupling members 33, 34 of the first mast 30 is the same as a length in the Z-axis direction of each of the coupling members 43, 44 of the second mast 40.

That is, each of the first mast 30 and the second mast 40 is a sheet metal mast, and the widths of the first mast 30 and the second mast 40 in the travelling direction are made different only by making the widths of the coupling members 33, 34 and the coupling members 43, 44 different. For this reason, the roller abutting member 31 and the back-side member 32 other than the coupling members 33, 34, 43, 44 are able to be made the same for the first mast 30 and the second mast 40. Accordingly, the cost for manufacturing the first mast 30 and the second mast 40 is able to be significantly reduced.

The roller abutting member 31 and the back-side member 32 are made uniform for the first mast 30 and the second mast 40. That is, in the first mast 30 and the second mast 40, the roller abutting member 31 and the back-side member 32 which are formed across the width direction seen from the travelling direction have the same structure. Hence, the configurations of the guide rollers where the platform 51 abuts on the respective two masts 30, 40 are able to be made the same. The shapes of portions of the two masts 30, 40 that guide the platform 51 are able to be made the same. Hence, application of a load between the platform 51 and the first mast 30 can be easily made equal to application of a load between the platform 51 and the second mast 40. Accordingly, the balance of weight on the right side and the left side is able to be easily maintained without complicating the configuration of the platform 51. Further, the cost for manufacturing the platform 51 is significantly reduced.

Each of the first mast 30 and the second mast 40 of this preferred embodiment is a sheet metal mast preferably formed by combining the plate-shaped members as described above as illustrated in FIGS. 4 and 5.

Specifically, in the first mast 30, the roller abutting members 31, the back-side members 32, and the coupling members 33, 34 are aligned in the height direction. Specifically, in the second mast 40, the roller abutting members 31, the back-side members 32, and the coupling members 43, 44 are aligned in the height direction.

The two adjacent roller abutting members 31 are connected by a first connecting member 35. The two adjacent back-side members 32 are connected by a second connecting member 36. The same applies to both the first mast 30 and the second mast 40.

As the first plate material, the second plate material, and a plate material for each of the coupling members 33, 34, 43, 44, for example, SS400, SPHC (Steel Plate Hot Commercial) or the like, which is a type of rolled steel for general structure, is preferably used, for example. Similarly, as a plate material for each of the first connecting member 35 and the second connecting member 36, SS4400, SPHC, or the like is preferably used, for example. Other materials which can obtain a predetermined rigidity may be used for these members.

In this preferred embodiment, as illustrated in FIG. 6, a fastening member 60 realized by a bolt, a rivet, or the like is used to join the members such as the roller abutting member 31, the back-side member 32, and the coupling members 33, 34, 43, 44. More specifically, a one-side bolt or a blind rivet which enables fastening in one-side operation may be used as the fastening member 60.

As illustrated in FIG. 6, the thickness of each of the coupling members 33, 34 in the first mast 30 is smaller than the thickness of the first plate material. Specifically, in the first mast 30, when the thickness of the first plate material (roller abutting member 31) is t11 and the thickness of each of the coupling members 33, 34 is t12, for example, t11 is about 5 mm and t12 is about 3 mm. Further, in the first mast 30, when the thickness of the second plate material (back-side member 32) is t13, t13 is about 3 mm or larger, for example. The same applies to the second mast 40. That is, in the second mast 40, when the thickness of the first plate material is t21, the thickness of each of the coupling members 43, 44 is t22, and the thickness of the second plate material is t23, t11 is equal to t21, t12 is equal to t22, and t13 is equal to t23, for example.

Note that the thickness of the plate-shaped member of the first mast 30 and the thickness of the plate-shaped member of the second mast 40 may not be the same. For example, the thickness of the plate-shaped member of the first mast 30 may be made larger than the thickness of the plate-shaped member of the second mast 40. That is, the thicknesses may be t11>t21, t12>t22, and t13>t23. Hence it is possible to improve the strength of the first mast 30 to which the self-weight of the mast and a load from the devices and the members having relatively large weight are likely to be applied.

As described above, the thicknesses of the two masts 30, 40 according to this preferred embodiment are made partially different. Specifically, each of the two masts 30, 40 includes the roller abutting member 31, the back-side member 32, and the coupling members 33, 34, 43, 44, which are separated from each other. Therefore, the thickness of each of the members is able to be independently determined.

In this preferred embodiment, the thickness of the roller abutting member 31, to which a large load is applied by the abutting of a plurality of guide rollers of the platform 51, is relatively large, and the thickness of each of the coupling members 33, 34, 43, 44 is relatively small.

That is, in the two masts 30, 40, the portion requiring a high rigidity and the portion not requiring a high rigidity are made to have different thicknesses. As a result, it is possible to reduce the weight of the two masts 30, 40 while ensuring the rigidity required for the whole of the two masts 30, 40.

Specifically, when each of the two masts 30, 40 is compared with a conventional square pipe having substantially the same rigidity as each of the masts, the weight of each of the two masts 30, 40 is able to be reduced to about half of the weight of the conventional square pipe.

Therefore, by adopting the two masts 30, 40 of this preferred embodiment, the mobility of the stacker crane 50 is significantly improved. Specifically, for example, the stacker crane 50 safely performs required operations such as acceleration, deceleration, and stopping of movement in the X-axis direction with smaller energy than the conventional stacker crane.

Further, in this preferred embodiment, the plurality of coupling members 33, 34, 43, 44 respectively include coupling members 33a, 34a, 43a, 44a and the coupling members 33b, 34b, 43b, 44b which have lengths (dimensions in the height direction; the same shall apply hereinafter) different from each other.

In this preferred embodiment, as illustrated in FIGS. 3 and 4, in the first mast 30, the lengths of the roller abutting member and the back-side member 32 preferably are the same (or substantially the same; the same shall apply hereinafter). The total length of the two roller abutting members 31 and the total length of the two coupling members 33a and one coupling member 33b preferably are the same. That is, the total length of the two roller abutting members 31 and the total length of the two coupling members 34a and one coupling member 34b preferably are the same.

For example, each of the roller abutting member 31, the back-side member 32, the coupling member 33b, and the coupling member 34b preferably has a length of about 1.7 m, and each of the coupling member 33a and the coupling member 34a has a length of about 0.85 m. In this case, the length (height) of the first mast 30 illustrated in FIGS. 2 and 3 preferably is about 3.4 m, for example. The same applies to the second mast 40. That is, the length of each of the coupling member 43b and the coupling member 44b preferably is about 1.7 m, which is equal to the length of each of the coupling member 33b and the coupling member 34b. Further, the length of each of the coupling member 43a and the coupling member 44a preferably is about 0.85 m, which is equal to the length of each of the coupling member 33a and the coupling member 34a.

In this preferred embodiment, the members are arranged in the two masts 30, 40 such that at least one boundary position between the aligned roller abutting members 31 is not the same in the height direction as at least one of the boundary position between the back-side members 32 and the boundary position between the coupling members 33, 34, 43, 44.

The stacker crane of the present invention has been described above based on a preferred embodiment. However, the present invention is not limited to the above preferred embodiment. Various modifications contrived by those skilled in the art applied to the above-described preferred embodiment or configurations built by combining the components are included in the scope of the present invention.

For example, although each of the two masts 30, 40 preferably is a sheet metal mast, the present invention is not limited thereto, and may be a mast formed of a square pipe. That is, the square pipe may be used as long as one of the two masts has a small width in the travelling direction and has the same width as seen from the travelling direction, as compared with the other mast. Further, it is more preferred that the two masts in this case have the same structure that extends across the width direction seen from the travelling direction in order to achieve an effect similar to the effect described in the above-described preferred embodiment.

For example, the present invention is not particularly limited to the method of joining the members of the two masts 30, 40. As the method of joining the members, in place of or in addition to fastening by the fastening members 60, joining by welding or an adhesive may be adopted.

For example, an adhesive and rivets as the fastening members 60 may be used together to join the members. That is, the members may be joined by combining a plurality of methods for joining, such as fastening by rivets and adhesion by an adhesive.

For example, the coupling members 33, 34, 43, 44 are not required to be arranged continuously in the height direction in the two masts 30, 40. For example, the plurality of coupling members 33, 34, 43, 44 may be aligned in the height direction at predetermined intervals.

The coupling members 33, 43 and the coupling members 34, 44 may be arranged alternately with each other in the height direction. That is, the coupling members 33, 34, 43, 44 may be discretely arranged when the rigidity required of the two masts 30, 40 can be ensured. Thus, the weight of the two masts 30, 40 is able to be further reduced.

Further, the first connecting member 35 and the second connecting member 36 are not essential elements in each of the two masts 30, 40. That is, even when the first connecting member 35 is not present, the two adjacent roller abutting members 31 are connected in the height direction via the coupling members 33, 34 joined thereto. Likewise, even when the second connecting member 36 is not present, the two adjacent back-side members 32 are connected in the height direction via a plurality of coupling members 33, 34.

The two masts 30, 40 may include only one of the first connecting member 35 and the second connecting member 36. For example, in each of the two masts 30, 40, only one of the first connecting member 35 and the second connecting member 36 may be arranged so that the right and left structures of the stacker crane 50 with the platform 51 taken at the center are the same.

Two first connecting members 35 or two second connecting members 36 may be provided. For example, the two first connecting members 35 may sandwich the joint between the two adjacent roller abutting members 31.

As a result, the strength of the joint between the roller abutting members 31 is able to be improved to reduce a deformation amount in the joint. In addition, as compared with a case where only one first connecting member 35 is arranged at the joint, the force applied to the fastening member 60 which joins the roller abutting member 31 and the first connecting member 35 is able to be distributed. As a result, the load resistance of each of the two masts 30, 40 are improved.

For example, in place of or in addition to the change in thickness of each of the back-side members 32 in accordance with the height position thereof, the thickness of at least one of each of the roller abutting members 31 and each of the coupling members 33, 34, 43, 44 may be changed in accordance with the height position thereof. For example, when the thickness of each of the plurality of roller abutting members 31 is changed in accordance with the height position thereof, similarly to the back-side members 32 of this preferred embodiment, each of the plurality of roller abutting members 31 is arranged so as to be sandwiched between the coupling members 33, 43 and the coupling members 34, 44. As a result, the second abutting surfaces 31b of the plurality of roller abutting members 31 are able to be flat with no steps.

The cross-sectional structures of the two masts 30, 40 according to the preferred embodiment and the alternative preferred embodiments thereof have been described with reference to FIG. 6. However, the features of these cross-sectional structures may be combined to produce a mast with a different cross-sectional structure.

Preferred embodiments of the present invention are useful as a stacker crane capable of making a space occupied by the masts small without complicating the structures of the masts and the platform.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stacker crane comprising:
a truck frame that travels on a track along a rack;
a mast provided on the truck frame; and
a platform that is raised and lowered along the mast; wherein
the mast includes a first mast that guides the platform, and a second mast located such that the platform is sandwiched between the first mast and the second mast in a travelling direction of the truck frame; and
as compared with the first mast, the second mast has a small width in the travelling direction of the truck frame, and has a same width as seen from the travelling direction.

2. The stacker crane according to claim 1, wherein the first mast and the second mast have a same structure that extends across a width direction seen from the travelling direction.

3. The stacker crane according to claim 2, wherein
each of the first mast and the second mast is a sheet metal mast including:
a roller abutting member which is a plate-shaped member on a platform side and on which a roller included in the platform abuts;
a back-side member that is a plate-shaped member opposite to the platform and facing the roller abutting member; and
a coupling member that is a plate-shaped member that couples the roller abutting member and the back-side member; and
the coupling member of the first mast has a larger width than a width of the coupling member of the second mast.

4. The stacker crane according to claim 3, wherein the plate-shaped member of the first mast has a larger thickness than a thickness of the plate-shaped member of the second mast.
